(19) United States
(12) Patent Application Publication
(10) Pub. No.: US 2018/0200959 A1
(43) Pub. Date: Jul. 19, 2018

(54) METHOD AND APPARATUS FOR MANUFACTURING A THREE-DIMENSIONAL OBJECT BY ADDITIVE LAYER MANUFACTURING

(71) Applicant: Airbus Operations GmbH., Hamburg (DE)

(72) Inventor: Thiago MEDEIROS ARAUJO, Hamburg (DE)

(21) Appl. No.: 15/869,427

(22) Filed: Jan. 12, 2018

(30) Foreign Application Priority Data
Jan. 13, 2017 (EP) 17275005.1

(51) Int. Cl. B29C 64/393; B29C 64/153; B29C 64/273; B33Y 10/00; B33Y 30/00; B33Y 50/02

(52) U.S. Cl. CPC B29C 64/393; B29C 64/153; B33Y 50/02; B33Y 10/00; B33Y 30/00; B29C 64/273

(57) ABSTRACT

A method of manufacturing a three-dimensional object which successively applies layers of material in powder form one on top of the other, wherein the first layer is applied to a support. Prior to providing the subsequent layer, each layer is irradiated selectively in a portion of the layer corresponding to a three-dimensional object being manufactured and wherein the irradiation is carried out in such a manner that the material is melted locally in the corresponding portions. The portions are each irradiated multiple times during multiple spaced time intervals. Operating parameters of the irradiation device (12) cause the polymer material to reach a melting temperature only during a second or a subsequent time interval. The energy introduced during each time interval is insufficient to heat the polymer material from a starting temperature to the melting temperature of the polymer material.

### RELATED APPLICATION

This application claims priority to European Patent Application EP Patent Application No. 17275005.1 filed Jan. 13, 2017, the entirety of which is incorporated by reference.

### FIELD OF THE INVENTION

The present invention relates to a method of manufacturing a three-dimensional object by additive layer manufacturing (ALM), in particular selective laser melting (SLM), and to a corresponding apparatus for manufacturing a three-dimensional object by additive layer manufacturing.

### BACKGROUND OF THE INVENTION

Additive layer manufacturing is increasingly used for rapidly manufacturing prototype or even final components and is then also referred to as rapid prototyping and rapid manufacturing, respectively. In contrast to conventional manufacturing methods involving removal of material from a block of material by, e.g., cutting, drilling or other machining processes, additive layer manufacturing directly constructs a desired three-dimensional object layer by layer from a digital representation of the object. It is also known as 3D printing.

A typical additive layer manufacturing method comprises providing a thin layer of material from which the product is to be manufactured in powder form on a support plate, melting, curing or sintering the powder in those portions of the layer corresponding to the product being manufactured by means of laser irradiation, subsequently providing a further thin layer of the material on top of the initial layer and again melting, curing or sintering the powder of the layer in those portions of the layer corresponding to the product being manufactured by means of laser irradiation, and repeating the process until the complete object is obtained. In each layer the powder not corresponding to the product is not irradiated and remains in powder form, so that it can be removed from the object at a later stage. The support plate may be provided by a movable table that—after each irradiation of a layer—is lowered a distance equal to the thickness of that layer to provide for a defined starting condition for the provision of each layer.

In this regard, it is to be noted that it is in principle possible that the individual layers are not entire or continuous layers of material, but comprise material only in the areas corresponding to the object being manufactured or in selected regions comprising those areas.

Known additive layer manufacturing methods as described above are typically carried out in chambers in which a tightly controlled constant inert gas atmosphere, e.g. argon, is maintained in order to avoid as far as possible reactions between the layers and surrounding gases upon laser irradiation.

Particular additive layer manufacturing methods of this type are also referred to as selective laser melting (SLM). In this regard, it is noted that instead of using a laser beam it is also possible to use an electron beam or another particle beam for the same purposes. A particular additive layer manufacturing method utilizing an electron beam is also referred to as electron beam melting (EBM).

As noted above, the object is built up layer by layer in a three-dimensional manner. This makes it possible to efficiently and rapidly manufacture different highly complex objects from various materials, such as metal materials, plastic or polymer materials and ceramic materials, using one and the same apparatus. For example, highly complex grid or honeycomb structures which are difficult to produce using other techniques can be easily manufactured. As compared to traditional methods, the complexity of the object has only little influence on the manufacturing costs.

When using additive layer manufacturing methods relying on a laser beam or particle beam together with a powder material having a relatively high melting temperature the layers are typically maintained at a temperature close to the melting temperature of the material such that the laser beam or particle beam only needs to introduce a relatively small amount of energy into the material in order to increase the irradiated portions to the melting temperature and thereby melt the material. Amongst others in the case of polymer materials, and in particular high temperature polymer materials, it must be taken into consideration that when maintaining the material at high temperatures close to the melting temperature for substantial periods of time, semi-sintering of the powder material may occur and the thermal history of the material may be negatively affected, resulting in a change of the intrinsic material properties. This may not only affect the properties of the irradiated regions, but also the powder material outside the portions of the layer corresponding to the product being manufactured. Consequently, the latter powder material, which could in principle be reused for the manufacturing of another three-dimensional object, may have to be discarded, resulting in waste of material and an increase in costs. For this reason it was suggested in WO 2012/160344 A1 to maintain the article during its production at a temperature above the glass transition temperature but significantly below the re-solidification temperature of the polymer. However, while this approach allows for a re-use of unirradiated powder material, it has been found that it is desirable to further optimize the material properties of the manufactured three-dimensional object.

### SUMMARY OF THE INVENTION

The inventors have conceived and disclosed herein a method and an apparatus system for manufacturing a three-dimensional object made of polymer material by additive layer manufacturing in a simple, rapid and cost efficient manner while at the same time guaranteeing good material properties.

The invention may be embodies as a method of manufacturing a three-dimensional object by additive layer manufacturing, comprising successively providing a plurality of layers of material in powder form, one on top of the other, on a support means and irradiating each layer with at least one laser or particle beam prior to providing the subsequent layer. Any such laser beam is generated by means of a laser, and any such particle beam is generated by means of a suitable particle beam generation device. In the following a laser or a particle beam generation device is referred to as irradiation device. The material in powder form is or comprises polymer material which has a glass transition temperature and is preferably thermoplastic, in particular a high-temperature polymer. Such high temperature polymers may have a melting temperature exceeding 250° C. The laser or particle beam is chosen such that the material at least partially absorbs the energy provided by the laser or particle beam. The support means is preferably arranged inside a chamber, which is also referred to as build chamber. Although using a laser beam is preferred, so that the irradiation device or irradiation devices is or are preferably a laser or lasers, in some applications the use of a particle beam may also be advantageous. For example, provided that low pressures can be present inside the chamber, the irradiation may be effected by means of an electron beam.

Typically the layers have thicknesses in the range of 20 to 100 μm, wherein the thicknesses are selected based on the desired surface finish quality and processing speed. Each layer is irradiated selectively only in those portions of the layer corresponding to the three-dimensional object being manufactured, and the irradiation is carried out in such a manner that the material of the respective layer is melted locally in the irradiated portions. This local melting serves to fuse the powder particles in the irradiated zones together and to the preceding layer.

The temperature of the layers is controlled such that prior to irradiation of each layer the temperature of the respective layer is in a range from the glass transition temperature of the polymer material to 30% above the glass transition temperature or, preferably or alternatively, in a range from the glass transition temperature to 60° C. above the glass transition temperature. The temperature is referred to as starting temperature. Preferably, the temperature of the current layer and of the previously deposited layers are maintained in this temperature range throughout the entire manufacturing process, with the exception of the portions being irradiated during irradiation and subsequent cooling thereof. The control of the temperature may preferably comprise controlling a temperature of the support means and/or—in the case of use of a build chamber—controlling a temperature inside the build chamber.

For each layer the irradiation is carried out in such a manner that each location or point of those portions of the layer corresponding to the three-dimensional object being manufactured is irradiated multiple times during or in multiple temporally spaced separate time intervals associated with the respective location. In each time interval the location is irradiated preferably only once. The time intervals are different for different locations, i.e. the time intervals are location-specific. In other words, for each location there are multiple time intervals during which energy is applied to the location by the laser beam or particle beam. The entirety of the locations constitutes the portions of the layer corresponding to the three-dimensional object being manufactured.

The operating parameters of the at least one irradiation device, and thus parameters determining the laser irradiation or particle beam irradiation, are chosen such that in each of the locations the polymer material reaches the melting temperature only during or after the second or a subsequent one of the time intervals associated with the respective location, i.e. during or after the second or a further irradiation, and that in each of the locations the laser energy or particle beam energy introduced during each of the associated time intervals is insufficient to heat the polymer material from the starting temperature to the melting temperature of the polymer material. Thus, in other words, the laser energy or particle beam energy applied during at least the first time interval or irradiation is not sufficient to heat the polymer material to the melting temperature, and in none of the time intervals the applied laser energy or particle beam energy is sufficient to heat the polymer material from the starting temperature to the melting temperature. Rather, the melting temperature is only reached during or after the last time interval, during or after the penultimate time interval or during or after an earlier time interval. Preferably, for each of the locations and each of the associated time intervals the applied laser energy or particle beam energy is at most 60%, preferably at most 50% and more preferably at most 40% of the energy necessary to heat the polymer material from the starting temperature to the melting temperature.

It has been found that by applying the laser energy or particle beam energy to each location in multiple spaced time intervals and in portions insufficient to heat the polymer material from the starting temperature in the specified range to the melting temperature, the material properties and mechanical characteristics of the finished three-dimensional object, such as, e.g., strength and/or ductility, can be increased significantly while maintaining the advantage of being able to re-use the powder material from the portions of the layers not corresponding to the three-dimensional object. It has been recognized in the context of the present invention that applying larger amounts of laser energy or particle beam energy may destroy the chemical bonds between the chains of the polymer materials and that this may result in a degradation of the material. The necessary changes in the irradiation can be provided for in a very simple manner while adding only little costs to the method and apparatus. Aside from the adaptation and control of the operating parameters of the irradiation device no additional work steps are required.

In an embodiment, each of the locations is irradiated at least three times, and the operating parameters of the at least one irradiation device are chosen such that in each of the locations the polymer material reaches the melting temperature during or after the penultimate or an earlier one of the time intervals associated with the respective location and is already molten before the beginning of the later one or ones of the time intervals associated with the respective location. For example, at each one of the locations the polymer material is already molten when beginning the last irradiation of that location or the melting temperature is already reached prior to the penultimate irradiation. Irradiating a location at which the polymer material is already molten may provide the advantage that the laser light or particles passes or pass through the molten material and is or are thereby able to reach the layer beneath the layer currently being irradiated, so that the bonding between the two layers is increased and a high material strength in the direction perpendicular to the extension of the layers can be achieved.

In an embodiment, for each of the layers the irradiation is carried out by scanning the at least one laser beam or particle beam over those portions of the layer corresponding to the three-dimensional object being manufactured in such a manner that for each of the locations and during each of the associated time intervals a laser beam or particle beam of the at least one laser beam or particle beam moves over the respective location in a defined movement direction. Further, for each of the locations at least two different movement directions are used for different ones of the associated time intervals. This provides for fast irradiation and homogenous material properties of the finished three-dimensional object by avoiding inhomogeneous application of laser energy or particle beam energy. It is further preferred if for each of the locations different movement directions are used for each two successive ones of the time intervals associated with the respective location. Alternatively or additionally it is also preferred if for each of the locations the at least two different movement directions comprise a first movement direction and a second movement direction oriented at an angle of larger than 0° to 90° and, e.g., 90° with respect to the first movement direction. In case only two different movement directions are used and are the first and second movement directions, the first and second movement directions alternate.

In these embodiments in which the irradiation is carried out by scanning, it is further preferred if for each of the layers the scanning of the at least one laser beam or particle beam comprises a plurality of separate scanning operations, during each of which a laser beam or particle beam of the at least one laser beam or particle beam is moved in a respective defined movement pattern over all of the locations or a contiguous subset of the locations, such that for each of the locations the irradiations during the respective time intervals are carried out during different ones of the scanning operations. For each of the locations the respective scanning operations comprise scanning operations having at least two different movement patterns. Different ones of the movement patterns differ from each other in the direction in which the respective laser beam or particle beam moves over the respective location. In particular, for each location two alternating movement patterns may be used for the multiple irradiations. It is preferred if for each of the locations the respective scanning operations comprise a first scanning operation having a first movement pattern and a second scanning operation having a second movement pattern which is a rotated version of the first movement pattern, e.g. by an angle from larger than 0° to 90°, for example by 90°. In case only two different movement patterns are used and are the first and second movement patterns, the first and second movement patterns alternate.

The at least one irradiation device is or comprises preferably a laser, which may further preferably be selected from the group consisting of CO2 lasers, diode lasers or fiber optic lasers.

In an embodiment, two or more irradiation devices are utilized for the irradiation of each of the layers. For example, different ones of the two or more irradiation devices may be utilized for different subsets of the locations and/or for different ones of the irradiations, such as for different ones of the above-mentioned scanning operations. The use of multiple irradiation devices decreases the processing time, thereby reducing the manufacturing time.

In an embodiment, for each of the layers and for each of the locations different operating parameters of the at least one irradiation device are used during different ones of the time intervals associated with the respective location.

Generally, the operating parameters of the at least one irradiation device may preferably comprise laser power or particle beam power, intensity distribution profile, spacing between adjacent paths of a movement pattern of the respective laser beam or particle beam, speed of movement of the laser beam or particle beam and/or pulse duration of a pulsed laser beam or particle beam.

In an embodiment, the polymer material is or comprises material selected from the group consisting of PA6, PA11, PA12, PARA, PPS, PBT and PAEK, including PEEK, PEK and PEKK. Alternatively or additionally the material in powder form may advantageously comprise the polymer material, such as, in particular, the above-mentioned particular polymer materials, as matrix into which glass—in particular in the form of fibers, beads and/or flakes—, carbon black, carbon fiber, graphene and/or aluminum—in particular in the form of fibers, beads and/or flakes—is embedded.

In an embodiment, the polymer material has a crystallization half time of at least three minutes, independent of the temperature of the polymer material. While it is also possible to process a polymer which presents a lower crystallization half time, it has been found that without providing strong additional support structures large degrees of material shrinkage and warping may occur due to internal stresses generated by a quick onset of crystallization upon cooling down following irradiation. By contrast, utilizing a material with the above minimum crystallization half time serves to prevent or at least minimize the necessity of additional support structures. This also decreases the failure rate of the manufacturing process.

The above-described inventive method can be advantageously carried out using an apparatus which comprises a housing defining a chamber, a support means disposed inside the chamber, a powder delivery means adapted for providing the plurality of layers of material in powder form one on top of the other on the support means, a temperature control means adapted for selectively controlling the temperature of each of the layers prior to irradiation thereof, at least one irradiation device, preferably at least one laser, adapted for irradiating each of the layers provided by the powder delivery means on the support means with a respective laser beam or particle beam, a beam movement means adapted for selectively irradiating only portions of each of the layers provided by the powder delivery means on the support means, a storage means for storing a digital representation of a three-dimensional object in the form of a plurality of layers, and a control unit operatively coupled to the powder delivery means, the temperature control means, the irradiation device, the beam movement means and the storage means and adapted for operating the powder delivery means, the temperature control means, the irradiation device and the beam movement means to manufacture a three-dimensional object in accordance with a digital representation of the object stored in the storage means and using the method according to any of the above-described embodiments.

In an embodiment, the powder delivery means comprises a rotatable roller and a roller drive arrangement. The roller drive arrangement is operable to simultaneously rotate the roller in a rotation direction and move it over the support means in a movement direction to distribute homogenously and in a defined thickness a layer of the material in powder form on the support means or a preceding layer. The rotating direction and the movement direction are such that a portion of the surface of the roller facing the layer moves into a direction opposite the movement direction. It has been found that when using such roller arrangement instead of a scraper, better spreading of the material across the support means may be achieved. Moreover, in case of any warping by the heated material, the contra-rotating roller is much more forgiving than a static scraper.

The invention may be embodied as a method of manufacturing a three-dimensional object by additive layer manufacturing and to a corresponding apparatus for carrying out the method. The comprises successively providing a plurality of layers of material in powder form, one on top of the other, on a support means. The material in powder form is or includes a polymer material. Prior to providing the subsequent layer, each layer is irradiated with at least one laser beam (13) or particle beam (13) using at least one irradiation device (12), wherein each layer is irradiated selectively only in those portions of the layer corresponding to the three-dimensional object being manufactured and wherein the irradiation is carried out in such a manner that the material is melted locally in the corresponding portions. The temperature of the layers is controlled such that prior to irradiation of each layer the respective layer has a starting temperature which is in a range from the glass transition temperature of the polymer material to 30% above the glass transition temperature. For each layer the irradiation is carried out in such a manner that each location of those portions of the layer corresponding to the three-dimensional object being manufactured is irradiated multiple times during multiple spaced time intervals associated with the respective location. Operating parameters of the at least one irradiation device (12) are chosen such that in each of the locations the polymer material reaches the melting temperature only during or after the second or a subsequent one of the time intervals associated with the respective location and that in each of the locations the energy introduced during each of the associated time intervals by the at least one laser beam (13) or particle beam (13) is insufficient to heat the polymer material from the starting temperature to the melting temperature of the polymer material.

### SUMMARY OF THE DRAWINGS

In the following an embodiment of the invention is explained in more detail with reference to the drawings.

FIG. 1 is a schematic representation of an apparatus according to the invention for manufacturing a three-dimensional object by selective layer melting.

FIG. 2 is a schematic representation of a sequence of movement patterns of scanning operations used for irradiating multiple times portions of a layer of the three-dimensional object to be manufactured.

FIG. 3 is a flow chart of an embodiment of a method according to the invention for manufacturing a three-dimensional object by additive layer manufacturing.

### DETAILED DESCRIPTION OF AN EMBODIMENT OF THE INVENTION

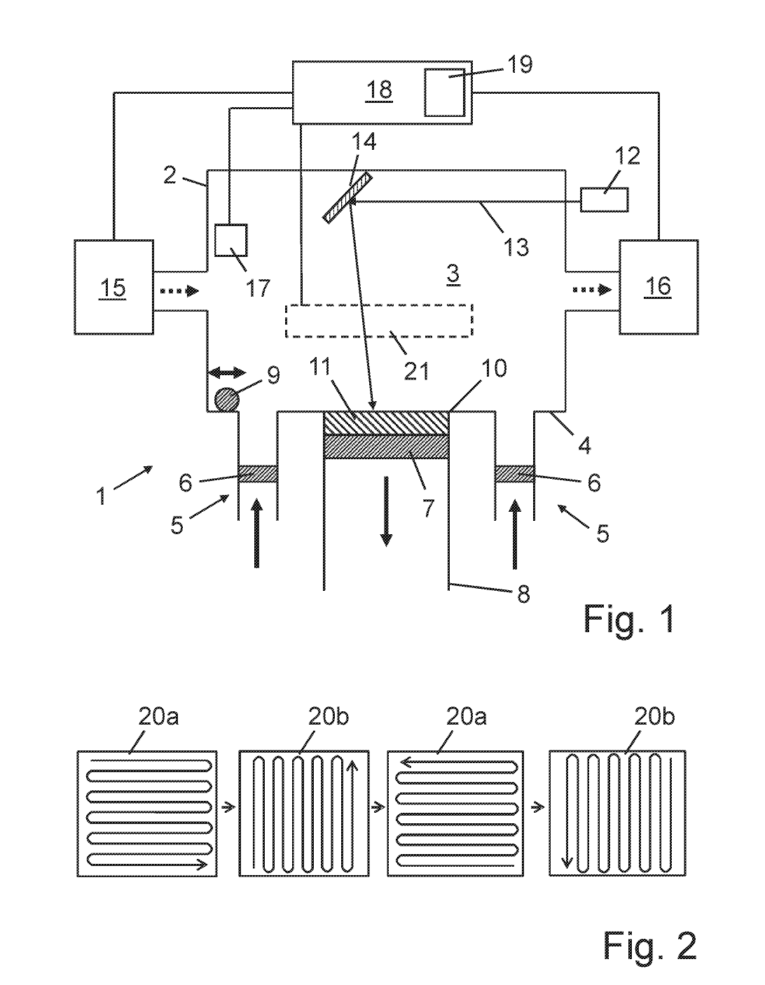

The apparatus 1 for selective laser melting (SLM) shown in FIG. 1 comprises a housing 2 defining an interior chamber 3. In the bottom wall 4 of the housing 2 two integrated powder containers 5 are provided, each having a bottom provided by a movable powder feed piston 6. Further, a portion of the bottom wall 4 of the housing 2 is defined by a movable support means or build platform 7. More particularly, the build platform 7 is movable upwardly and downwardly inside a channel-shaped extension 8 of the housing 2 and sealingly engages the channel walls thereof.

In operation powder, which is or comprises a polymer material and which is stored in the powder containers 5 is fed into the chamber 3 by moving upwardly one or both of the powder feed pistons 6 and is distributed as a thin layer on the top surface of the build platform 7 or of a partial object 11 disposed thereon by operating a powder spreading roller 9 which is movable in the horizontal direction. In this regard, prior to operating the powder spreading roller 9 the build platform 7 is moved downwardly inside the channel 8 such that the vertical distance between the upper end 10 or the bottom wall 4 of the housing 2 and the top surface of the build platform 7 or a partial object 11 disposed thereon is identical to the thickness of the powder layer to be distributed. The powder spreading roller 9 is operated in such a manner that during each horizontal movement of the roller 9 the direction of rotation of the roller 9 is such that the horizontal tangential direction of movement of the portion of the roller facing the partial object 11 is opposite the direction of the horizontal movement of the entire roller 9.

After each powder layer has been distributed a laser 12 is operated to irradiate the layer with a laser beam 13. The laser beam 13 is moved over the layer by means of one or more movable mirrors 14, which may take the form of mirror galvanometers and may be controlled in analog or digital form. The laser 12 and the mirror or mirrors 14 are operated in such a manner that only selective portions of the layer are irradiated. In those portions the powder melts and forms a part of a three-dimensional object corresponding to the respective layer.

Following the irradiation the above steps are repeated, i.e. the build platform 7 is moved downwardly by a distance corresponding to the thickness of the subsequent layer, and the subsequent layer is provided on top of the previous layer by means of the powder feed pistons and the powder spreading roller 9 and is irradiated by means of the laser 12 and the mirror or mirrors 14.

The above process is carried out automatically under the control of a control unit 18. For this purpose, the control unit 18 is operatively coupled to the powder feed pistons 6, the build platform 7, the powder spreading roller 9, the laser 12 and the mirror or mirrors 14 (for reasons of clarity of the Figure these couplings are not shown in the Figure) such that it can move and operate these elements as described above. The control is effected on the basis of digital data stored in a memory 19 of the control unit 18. For manufacturing a particular three-dimensional object, digital data are stored in the memory 19 describing layer for layer the structure of the object.

During irradiation of each of the layers a defined gas atmosphere is maintained inside the chamber 3, such as, e.g., a gas atmosphere having an oxygen content of less than 5%. For this purpose, the apparatus 1 comprises a gas supply system 15 and a gas venting system 16. The gas supply system 15 comprises suitable tanks or containers for one or more gases and one or more valves and pumps for selectively introducing gas from one or more of the tanks or containers into the chamber 3. The gas venting system 16 comprises one or more valves and pumps for removing gas from the chamber 3. Further, a detector 17 is disposed inside the chamber 3, which detector 17 is operable to detect particular characteristics of the gas atmosphere present inside the chamber 3 and to provide corresponding detection signals.

As shown in FIG. 1, the gas supply system 15, the gas venting system 16 and the detector 17 are operatively coupled to the control unit 18 such that in operation the control unit 18 can send control signals to the gas supply system 15 and the gas venting system 16 and can receive status signals from the gas supply system 15 and the gas venting system 16 and the detection signals provided by the detector 17. This allows for an automatic control of the gas atmosphere by the control unit 18.

The apparatus 1 also includes a heating device 21 disposed inside the chamber 3 and adapted for heating the partial object 11 and the current layer to a defined temperature which is in a range from the glass transition temperature of the polymer material to 30% above the glass transition temperature. For example, the heating device 21 may comprise one or more infrared heaters. The heating device 21 is operable to maintain, prior to, during and after irradiation of each of the layers, a defined temperature of the layers, with the exception of the regions currently being heated by laser irradiation. As shown in FIG. 1, the heating device 21 is likewise coupled to the control unit 18, such that in operation the control unit 18 can send control signals to the heating device 21. Preferably, there is also a heating device (not shown) which is adapted to heat the powder contained in the powder containers 5. The powder in the powder containers 5 is then preferably heated or pre-heated to a temperature which is much lower than the temperature to which the layers are heated by the heating device 21, e.g. to a temperature which is between 10 and 60° C. below the temperature to which the layers are heated by the heating device 21.

For manufacturing a particular three-dimensional object, the digital data mentioned above comprise for each layer a sequence of movement patterns 20a, 20b, which is illustrated for the particular example of a cuboidal three-dimensional object in FIG. 2 and which describes a sequence of separate scanning operations. During each scanning operation the laser beam 13 is moved over the surface of the current layer in accordance with the respective movement pattern 20a, 20b. Further, for each layer the digital data comprise values for operating parameters influencing the amount of laser energy which is applied to each location of the layer during each of the scanning operations. Examples of operating parameters are the movement speed and the laser power. It should be noted that the amount of laser energy may alternatively or additionally also be determined by the distance between adjacent movement paths of the respective movement pattern 20a, 20b. The values for the operating parameters are chosen such that the amount of energy applied during each scanning operation is not sufficient to heat the polymer material from the defined starting temperature to the melting temperature of the polymer material, but that the melting temperature is reached after the second, third or fourth scanning operation.

The movement patterns 20a, 20b and the sequence in which they are arranged are chosen such that during each two successive scanning operations the direction of movement of the laser beam over each location of the layer being irradiated differs by 90°. For this purpose, in the example of FIG. 2 the two movement patterns 20a, 20b are arranged alternatingly in the sequence, and the movement pattern 20b corresponds to the movement pattern 20a rotated by 90°.

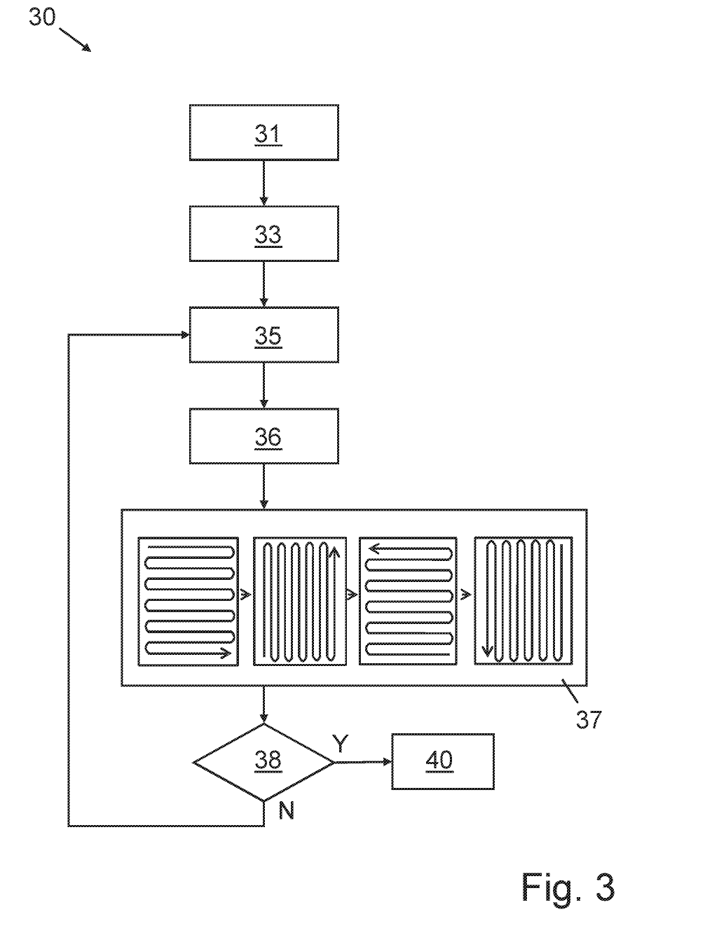

FIG. 3 shows an embodiment of a method 30 of manufacturing a defined three-dimensional object using the apparatus 1.

In step 31 digital data are stored in the memory 19 describing layer for layer the structure of the object. These data are adapted for providing information to the control unit 18 allowing it to control the powder feed pistons 6, the build platform 7, the powder spreading roller 9, the laser 12 and the mirror or mirrors 14 such that they are operated such that the final object has the desired structure. The digital data comprise, for each layer, the sequence of the plurality of different movement patterns 20a, 20b and of the values of operating parameters.

Moreover, in step 33 digital data are stored in the memory 19 defining the pressure and composition of the gas atmosphere to be used as well as the temperature of the object being manufactured and the layers prior to irradiation thereof. The temperature is in a range from the glass transition temperature of the polymer material to 30% above the glass transition temperature.

The storing of the various digital data in the memory 19 may e.g. be carried out by inserting a removable data carrier storing the data into a corresponding reading device provided in the control unit 18, wherein the control unit 18 is operable for transferring the data from the removable data carrier to the memory 19. In addition or alternatively, the control unit 18 may be connected or connectable to a wired or wireless data transmission network over which the digital data to be stored in the memory 19 can be received by the control unit 18.

Next, based on the digital data the gas atmosphere in the chamber 3 and the temperature of the build platform 7 and the object being manufactured are controlled in accordance with the digital data. Once this has been done, the build platform 7 is positioned in the above-described manner to receive the current layer of powder material (step 35) and the powder feed pistons 6 and the powder spreading roller 9 are operated to provide the layer of powder material on the build platform 7, which layer is likewise controlled to have the temperature provided for by the digital data (step 36). The laser 12 and the mirror or mirrors 14 are then operated to irradiate the layer in accordance with the corresponding structural digital data and the sequence of scanning operations associated with the respective layer (step 37).

Following the irradiation of each of the layers it is determined whether the current layer is the last layer (step 38) and the process is ended if that is the case. Otherwise, the method reverts to step 35 for positioning the build platform 7 for receipt of the subsequent layer (step 38).

The above steps are repeated until the last layer has been irradiated and the object is completed (step 40).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A method of manufacturing a three-dimensional object by additive layer manufacturing, comprising the following steps:
successively providing a plurality of layers of material in powder form, one on top of the other, on a support, wherein the material in powder form is or comprises polymer material, and
irradiating each of the plurality of layers, prior to providing a subsequent layer of the plurality of layers, with at least one laser beam or particle beam using at least one irradiation device, wherein each of the plurality of layers is irradiated selectively only in a portion of the layer corresponding to the three-dimensional object being manufactured and wherein the irradiation is carried out in such a manner that the material is melted locally in the portions,
wherein a temperature of the plurality of layers is controlled such that prior to irradiation of each layer the respective layer has a starting temperature which is in a range from a glass transition temperature of the polymer material to 30% above the glass transition temperature, and
wherein for each layer of the plurality of layers the irradiation is carried out in such a manner that each location of the portion of the layer corresponding to the three-dimensional object being manufactured is irradiated multiple times during multiple spaced time intervals associated with the respective location,
wherein operating parameters of the at least one irradiation device are chosen such that in each of the locations the polymer material reaches the melting temperature only during or after the second or a subsequent one of the time intervals associated with the respective location and that in each of the locations the energy introduced during each of the associated time intervals by the at least one laser beam or particle beam is insufficient to heat the polymer material from the starting temperature to the melting temperature of the polymer material.

2. The method according to claim 1, wherein each of the locations is irradiated at least three times, and wherein the operating parameters of the at least one irradiation device are chosen such that in each of the locations the polymer material reaches the melting temperature during or after the penultimate or an earlier one of the time intervals associated with the respective location and is already molten before the beginning of the later one or ones of the time intervals associated with the respective location.

3. The method according to claim 1, wherein for each of the layers the irradiation is carried out by scanning the at least one laser beam or particle beam over those portions of the layer corresponding to the three-dimensional object being manufactured in such a manner that for each of the locations and during each of the associated time intervals a laser beam or particle beam of the at least one laser beam or particle beam moves over the respective location in a defined movement direction, wherein for each of the locations at least two different movement directions are used for different ones of the associated time intervals.

4. The method according to claim 3, wherein for each of the locations different movement directions are used for each two successive ones of the time intervals associated with the respective location.

5. The method according to claim 3, wherein for each of the locations the at least two different movement directions comprise a first movement direction and a second movement direction oriented at an angle of from larger than 0° to 90° with respect to the first movement direction.

6. The method according to claim 3, wherein for each of the plurality of layers the scanning of the at least one laser beam or particle beam comprises a plurality of separate scanning operations, during each of which a laser beam or particle beam of the at least one laser beam or particle beam is moved in a respective defined movement pattern over all of the locations or a contiguous subset of the locations, such that for each of the locations the irradiations during the respective time intervals are carried out during different ones of the scanning operations, wherein for each of the locations the respective scanning operations comprise scanning operations having at least two different movement patterns.

7. The method according to claim 6, wherein for each of the locations the respective scanning operations comprise a first scanning operation having a first movement pattern and a second scanning operation having a second movement pattern which is a rotated version of the first movement pattern.

8. The method according to claim 1, wherein the at least one irradiation device is at least one laser which is selected from a group consisting of CO2 lasers, a diode lasers and fiber optic lasers.

9. The method according to claim 1, wherein the irradiation devices includes two or more irradiation devices each are utilized for the irradiation of each of the plurality of layers.

10. The method according to claim 1, wherein for each of the plurality layers and for each of the locations different operating parameters of the at least one irradiation device are used during different ones of the time intervals associated with the respective location.

11. The method according to claim 1, wherein the operating parameters of the at least one irradiation device comprise laser power or particle beam power, intensity distribution profile, spacing between adjacent paths of a movement pattern of the respective laser beam or particle beam, speed of movement of the laser beam or particle beam and/or pulse duration of a pulsed laser beam or particle beam.

12. The method according to claim 1, wherein the polymer material is or comprises material selected from a group consisting of PA6, PA11, PA12, PARA, PPS, PBT, PAEK, including PEEK, PEK and PEKK, and/or wherein the material in powder form comprises the polymer material as matrix into which glass, carbon black, carbon fiber, graphene and/or aluminum is embedded.

13. The method according to claim 1, wherein the polymer material has a crystallization half time of at least three minutes.

14. An apparatus for manufacturing a three-dimensional object by additive layer manufacturing, the apparatus comprising:
a housing defining a chamber,
a support disposed inside the chamber,
a powder delivery controller adapted for providing the plurality of layers of material in powder form one on top of the other on the support,
a temperature controller adapted for selectively controlling the temperature of each of the layers prior to irradiation thereof,
at least one irradiation device adapted for irradiating each of the layers provided by the powder delivery controller on the support with a respective laser beam or particle beam,
a beam movement controller adapted for selectively irradiating only portions of each of the layers provided by the powder delivery controller on the support,
a non-transitory storage device configured to store a digital representation of a three-dimensional object in the form of a plurality of layers, and
a control unit operatively coupled to the powder delivery controller, the temperature controller, the irradiation device, the beam movement controller and the storage device and adapted to operate the powder delivery controller, the temperature controller, the irradiation device and the beam movement controller to manufacture a three-dimensional object in accordance with a digital representation of the object stored in the storage device.

15. The apparatus according to claim 14, wherein the powder delivery controller comprises a rotatable roller and a roller drive arrangement, wherein the roller drive arrangement is operable to simultaneously rotate the roller in a rotation direction and move the roller over the support in a movement direction to distribute homogenously and in a defined thickness a layer of the material in powder form on the support or on a preceding layer, wherein the rotating direction and the movement direction are such that a portion of the surface of the roller facing the layer moves into a direction opposite the movement direction.

16. A method to manufacture a three-dimensional object comprising:
forming a layer of a powdered polymer material on a support surface or a previously formed layer of the powdered material,
irradiating the layer of the powdered polymer material, wherein the irradiation confined to a portion of the layer corresponding to the three-dimensional object being manufactured, wherein the irradiation is performed such that the layer is repeatedly irradiated with intervals between each of the repeated irradiations, wherein energy collectively applied to the layer during of the repeated irradiations is sufficient to melt the powdered polymer material, and energy applied during a first of the repeated irradiations is insufficient by itself to melt the powdered polymer material of the layer, and
forming another layer of the powered material on the layer and after the irradiation of the layer.

17. The method of claim 16 wherein the steps of the forming the layer, irradiating the layer and the forming the another layer are repeated to form the three-dimensional object.

18. The method of claim 16 further comprising maintaining a temperature of the layer before the irradiation of the layer to a range from a glass transition temperature of the powdered polymer material to 30% above the glass transition temperature.

19. The method of claim 16 further comprising irradiating the another layer of the powdered polymer material, wherein the irradiation is confined to a portion of the another layer corresponding to the three-dimensional object being manufactured, wherein the irradiation is performed such that the another layer is repeatedly irradiated with intervals between each of the repeated irradiations, wherein energy collectively applied to the another layer during of the repeated irradiations is sufficient to melt the powdered polymer material, and energy applied during a first of the repeated irradiations is insufficient by itself to melt the powdered polymer material of the another layer.

20. The method of claim 16 wherein the irradiation of the layer is by a laser beam or a particle beam.
